(19) United States
(12) Patent Application Publication
(10) Pub. No.: US 2014/0091785 A1
(43) Pub. Date: Apr. 3, 2014

(54) TARGET CLEARANCE MEASUREMENT DEVICE

(71) Applicant: Salunda Limited, Oxford (GB)

(72) Inventors: Peter Wherritt, Abingdon (GB); Martin Roy Harrison, Brackley (GB); Alexy Davison Karenowska, Oxford (GB); John Francis Gregg, Oxford (GB); Philip Pickles, Oxford (GB)

(73) Assignee: Salunda Limited, Oxford (GB)

(21) Appl. No.: 14/041,801

(22) Filed: Sep. 30, 2013

(30) Foreign Application Priority Data
Sep. 28, 2012 (GB) 1217434.8

(51) Int. Cl. G01B 7/14

(52) U.S. Cl. CPC G01B 7/14
USPC 324/207.15

(57) ABSTRACT

A target or rotor blade clearance measurement device is disclosed for indicating an interaction of a measurement probe with a target or rotor blade. In a preferred embodiment, the measurement device comprises a measurement probe containing a coil, a frequency source arranged to apply an input alternating signal to the measurement probe, and a frequency regulator arranged to regulate the input alternating signal at a frequency below the resonance frequency of the measurement probe. A detector is arranged to detect an output signal from the measurement probe at a frequency of the frequency source which varies in amplitude with an admittance and resonance frequency of the measurement probe. A circuit is arranged to scale the amplitude of the output signal detected by the detector according to the amplitude of the input signal provided by the frequency source.

### FIELD OF THE INVENTION

The present invention relates to a target clearance measurement device and in particular an aero engine turbine rotor blade clearance measurement device.

### BACKGROUND OF THE INVENTION

Under normal operating conditions, the radial and axial position(s) of the blade(s) of an aero engine jet turbine vary over a range of up to several millimetres relative to their position when the engine is cold and unloaded. So as to optimize the efficiency of an engine it is desirable to measure and control the speed and position of the turbine blades relative to the engine casing. One means to implement such a measurement system is to install a device in the engine casing capable of a) detecting the presence/proximity of the blade tips and/or measuring the distance between the casing and the blades (“the blade clearance” b) measuring the blade pass rate, from which the rotational speed of the turbine may be inferred.

In the context of such a measurement, two quantities are important: the radial distance between the blade tips and the turbine casing, and the axial position of the turbine blades relative to a fixed point on the casing. The latter may be quantified in terms of an axial offset dₐ between the turbine blades and a fixed point on the turbine casing defined such that when the engine is cold and unloaded dₐ=0 (see FIG. 1a).

The radial blade tip to casing distance dᵣ takes a maximum value when the engine is cold and unloaded and reduces under load as a result of the combined effects of heating and centripetal acceleration of the blades. Axial shift of the blades is due to the displacement of the turbine under load. Relative to its position in the cold, static engine, the majority of the axial shift of the turbine is toward the rear of the casing (negative shift), but a small displacement toward the front of the engine (positive shift) is also possible (see FIG. 1b).

A first technology (US2010213929, WO2010082035 and associated applications) has been developed and optimized for accurate quantitative measurements of the blade-tip clearance dᵣ. However, this approach only delivers good results over a relatively restricted range of axial offset values dₐ.

Therefore, there is required a system and method which combines the advantages of long-range functionality and high-accuracy clearance measurement capability.

### SUMMARY OF THE INVENTION

Against this background and in accordance with a first aspect there is provided a target or rotor blade clearance measurement device comprising: a measurement probe containing a coil and having some inductance and some capacitance and an admittance and resonance frequency that change as the separation of the measurement probe and a target or rotor blade changes; a frequency source arranged to apply at an amplitude, an input alternating signal to the measurement probe; a frequency regulator arranged to regulate the input alternating signal at a frequency below the resonance frequency of the measurement probe; a detector arranged to detect an output signal from the measurement probe at the frequency of the frequency source that varies in amplitude with the admittance and resonance frequency of the measurement probe indicating an interaction of the measurement probe with the target or rotor blade; a circuit arranged to scale the amplitude of the output signal detected by the detector according to the amplitude of the input signal provided by the frequency source.

The frequency source, frequency regulator, detector and scaling circuit form part of measurement circuitry.

The system described above affords both (1) high sensitivity and thus long measurement range (achieved by means of the particular configuration of the frequency source, frequency regulator, and detector described), and (2) the ability to make highly accurate measurements of the absolute blade clearance (achieved by means of the amplitude scaling circuitry).

Optionally, the target or rotor blade clearance measurement device further comprises a feature or features to enable the real-time monitoring of the integrity of the measurement probe. Such feature(s) facilitate the identification of measurement probe failure which is advantageous from the point of view of safeguarding the integrity and proper functioning of the engine in which the device is installed. One such optional feature is a circuit which passes a small DC current through the measurement probe. In one preferred implementation of such a circuit, this current is arranged to flow by connecting the probe between two non-equal voltages V_{A} and V_{B}, (V_{A}>V_{B}) via two resistors: one from V_{A} to one end of the probe (a) the other from V_{B}, to the other end of the probe (b). If the probe is intact, the voltages at a and b are respectively, slightly below V_{A}, and slightly above V_{B}. If the probe fails in an open-circuit fashion, the voltage at a is equal to V_{A}, and the voltage at b is equal to V_{B}. If the probe fails by shorting to ground, either one or both of the voltages at a or b is ground. By measuring the voltage difference across the probe, its resistance can be calculated. This resistance is, in turn, a measure of the temperature of the coil inside the probe. Knowledge of this temperature can be used to improve the accuracy of the blade clearance measurement. In such an implementation of a real-time monitoring feature, it is necessary to ensure that the current path through the probe and the resistors does not load the AC circuitry associated with the frequency source and detector. For this purpose, a filter is preferably employed.

Optionally, the target or rotor blade clearance measurement device further comprises a feature or features for verifying that the measurement circuitry is fully functional. In one preferred implementation of such a validation feature a switchable electrical impedance is placed across the connections from the measurement circuitry to the probe. In normal operation this impedance is switched out of circuit. However, when verification of the proper functioning of the measurement circuitry is required, the impedance is switched alternately in and out of the circuit (at a frequency, for example, of 1 kHz, though a wide range of other frequencies may be used). Viewed from the measurement circuitry, the effect of this switching is equivalent to that produced by interaction between the measurement probe and passing targets or rotor blades. Hence, the switched impedance creates a “simulated” blade-pass signal. Analyzing the response of the measurement circuitry to this simulated blade-pass signal allows the integrity both of the measurement circuitry, and of the measurement probe to be verified.

It is a particular feature of the blade clearance measurement device that the frequency source is regulated to a frequency which is, for all operating conditions and both in the presence and absence of interaction between the measurement probe and a target or rotor blade, simultaneously: (a) not less than ω₀/Q below the resonance frequency ω₀ of the measurement probe (Q being the quality factor of the measurement probe), and (b) not below the frequency ω_{L}=R*/L where R* is the sum of the source impedance from which the measurement probe is driven and its resistance, and L is its inductance. Preferably, Q may be between 2 and 20. Other values of Q may be used such as below 50 and between 10 and 20, for example and the Q may vary depending on the operating conditions of the measurement device.

Preferably, the frequency source may be regulated to between 100 KHz and 400 MHz but other radio- or microwave-frequencies may be used.

Optionally, the measurement circuitry may be further arranged to indicate that the target or rotor blade clearance is within a range of clearances.

Optionally, the target or rotor blade clearance measurement device may be further configured to provide an indication of a speed or speed of rotation of the rotor blades by detecting the rate at which the target or rotor blades pass in front of the measurement probe.

Optionally, the detector of the target or rotor blade clearance measurement device further comprises a fast analogue to digital converter gate array based signal processing circuit used to measure or monitor the profiles of the passing blades.

Optionally, the measurement circuitry may be further configured to determine at intervals the resonance frequency of the measurement probe. This may improve clearance measurement accuracy by calibrating the device at intervals or when the rotor blades are stationary.

According to a second aspect there is provided an aero engine comprising the target or rotor blade clearance measurement device according to the foregoing description.

According to a third aspect there is provided a system comprising two measurement probes mounted in axially offset positions and connected to a measurement circuitry comprising a common frequency source but two separate detectors arranged to detect and process the received signals from each probe separately (see FIG. 1c). When the blades move in the forward direction they are predominantly detected by the forward mounted probe (probe 1 in FIG. 1c), whilst when they move in the rearward direction they are predominantly detected by the rearward probe (probe 2 in FIG. 1c). By combining the information from the two probes the blade clearance can be measured more accurately and over a wider range than is possible with a single probe. In addition, the axial displacement of the target or rotor blades can be accurately determined.

According to a fourth aspect there is provided a system comprising: a plurality of the target or rotor blade clearance measurement devices according to the foregoing description; a single transmission line configured to provide an electrical connection between each measurement probe and its corresponding measurement circuitry, wherein each measurement circuitry is configured to operate its corresponding probe at a different frequency. Therefore, an array or arrangement of measurement devices may be used with reduced cabling.

According to a fifth aspect there is provided a method of measuring target or rotor blade clearance comprising the steps of: providing a measurement probe containing a coil having some inductance and some capacitance and an admittance and resonance frequency that change as the separation of the measurement probe and a target or rotor blade changes; driving the measurement probe with an input alternating signal regulated to a frequency below the resonance frequency of the measurement probe; detecting an output signal from the measurement probe at the frequency of the input alternating signal that varies in amplitude with the admittance and resonance frequency of the measurement probe indicating an interaction of the measurement probe with a target or rotor blade and scaling the amplitude of the output signal detected according to the amplitude of the input signal provided by the frequency source.

Optionally, the method may further comprise the step of determining the resonance frequency of the measurement probe and regulating the frequency source through the use of the frequency regulator to operate at a frequency below this determined resonance frequency.

Optionally, the method may further comprise the step of monitoring the integrity of the measurement probe in real time by means of passing a small current through the measurement probe which is arranged to flow by connecting the probe between two non-equal voltages V_{A} and V_{B} via two resistors: one from V_{A} to one end of the probe, the other from V_{B} to the other end of the probe, measuring the voltage difference across the probe, and using a filter to prevent the current path through the resistors and the probe from loading the AC circuitry associated with the frequency source and detector.

Optionally, the method may further comprise the step of verifying that the measurement circuitry is fully functional by switching an electrical impedance across the connections from the measurement circuitry to the probe in a controlled manner.

Preferably, the frequency source is regulated to a frequency which is, under all operating conditions and both in the presence and absence of interaction between the measurement probe and a rotor blade, simultaneously: (a) not less than ω₀/Q below the resonance frequency ω₀ of the measurement probe (Q being the quality factor of the measurement probe), and (b) not below the frequency ω_{L}=R*/L where R* is the sum of the source impedance from which the measurement probe is driven and its resistance, and L is its inductance. Preferably, Q may be between 2 and 20. Other values of Q may be used such as below 50 and between 10 and 20, for example and the Q may vary depending on the operating conditions of the measurement device.

Preferably, the frequency source is regulated to between 100 KHz and 400 MHz but other radio- or microwave-frequencies may be used.

The methods described above may be implemented as a computer program comprising program instructions to operate a computer, processor or integrated circuit. The computer program may be stored on a computer-readable medium or stored as firmware.

It should be noted that any feature described above may be used with any particular aspect or embodiment of the invention.

Further illustrative examples are provided by the following numbered clauses:

1. A target measurement device comprising:

a measurement probe containing a coil and having some inductance and some capacitance and an admittance and a resonance frequency that change as the separation of the measurement probe and a target changes;

a frequency source arranged to apply at an amplitude, an input alternating signal to the measurement probe;

a frequency regulator arranged to regulate the input alternating signal at a frequency below the resonance frequency of the measurement probe;

a detector arranged to detect an output signal from the measurement probe at the frequency of the frequency source that varies in amplitude with the admittance and resonance frequency of the measurement probe indicating an interaction of the measurement probe with the target;

and a circuit arranged to scale the amplitude of the output signal detected by the detector according to the amplitude of the input signal provided by the frequency source.

2. The target measurement device of clause 1 further comprising a demodulator arranged to demodulate the output signal from the measurement probe.
3. The target measurement device of clause 1 or clause 2 further comprising a circuit arranged to determine the resonance frequency of the measurement probe.
4. The target measurement device according to any previous clause, wherein the frequency source operates at constant frequency.
5. The target measurement device according to any previous clause, wherein the frequency source is regulated to a frequency which is, both in the presence and absence of interaction between the measurement probe and a target, simultaneously: (a) not less than ω₀/Q below the resonance frequency ω₀ of the measurement probe (Q being the quality factor of the measurement probe), and (b) not below the frequency ω_{L}=R*/L where R* is the sum of a source impedance from which the measurement probe is driven and its resistance, and L is its inductance.
6. The target measurement device according to any previous clause, wherein the frequency source is regulated to between 100 KHz and 400 MHz.
7. The target measurement device according to any previous clause, wherein Q is between 2 and 20.
8. The target measurement device according to any previous clause further comprising circuitry arranged to indicate an absolute target clearance from the amplitude of the measurement probe output signal.
9. The target measurement device according to any previous clause further comprising circuitry arranged to indicate that target clearance is within a range of clearances.
10. The target measurement device according to any previous clause further comprising circuitry arranged to indicate the speed of the target.
11. The target measurement device according to any previous clause further comprising circuitry configured to determine at intervals the resonance frequency of the measurement probe.
12. The target measurement device according to any previous clause further comprising a validation circuit to enable real-time monitoring of the integrity of the measurement device.
13. The target measurement device of clause 12 in which the validation circuit is arranged to pass a current through the measurement probe by connecting the probe between two non-equal voltages V_{A} and V_{B} via two resistors: one from V_{A} to one end of the probe, the other from V_{B} to the other end of the probe and to measure the resulting voltage difference across the probe.
14. The target measurement device of clause 13 in which the validation circuit is further arranged to calculate the temperature of the coil inside the probe from the resistance of the probe, the resistance being determined from the measured voltage difference across the probe.
15. The target measurement device of clause 13 or 14 in which the validation circuitry further comprises a filter arranged to prevent a current path through the probe and the two resistors from loading the frequency source and detector.
16. The target measurement device of any of clauses 12 to 15 in which the validation circuit further comprises an electrical impedance placed across the measurement probe and configured to be switched alternately in and out.
17. The target measurement device of clause 16 in which the impedance is configured to be switched at between 500 Hz and 10 MHz.
18. The target measurement device of any previous clause in which the detector further comprises a fast analogue to digital converter gate array based signal processing circuit designed to recover information about profiles of the targets from the probe output signal.
19. The target measurement device of any previous clause further comprising a second measurement probe mounted axially offset to the first measurement probe and connected to the frequency source; and

a second detector arranged to separately detect and process the output signal from the second measurement probe.

20. The target measurement device of any previous clause, wherein the target is selected from the group comprising: a rotor, a rotor blade, a rotor blade tip, a surface, a conductive surface, a pipe, a tube, or a well-casing.
21. A system comprising:

a plurality of the target measurement device according to any previous clause;

a transmission line configured to provide an electrical connection between each measurement probe and its corresponding frequency source and detector, wherein each frequency source is configured to supply its corresponding measurement probe with an input alternating signal at a different frequency.

22. The system of clause 21 further comprising a multiplexor arranged to maintain electrical connection within the transmission line.
23. An aeroengine comprising the target measurement device according to any of clauses 1 to 20 or the system of clause 21 or clause 22.
24. A method of measuring target clearance comprising the steps of:

providing a measurement probe containing a coil and having some inductance and capacitance and an admittance and a resonance frequency that change as the separation of the measurement probe and a target changes;

driving the measurement probe with an input alternating signal from a frequency source at an amplitude regulated to a frequency below the resonance frequency of the measurement probe;

detecting an output signal from the measurement probe at the frequency of the input alternating signal that varies in amplitude with the admittance and resonance frequency of the measurement probe indicating an interaction of the measurement probe with the target, and

scaling the amplitude of the output signal detected according to the amplitude of the input signal provided by the frequency source.

25. The method of clause 24, wherein the output signal from the measurement probe is demodulated.
26. The method of clauses 24 or 25, wherein the frequency source operates at constant frequency.
27. The method according to any of clauses 24 to 26 further comprising the step of determining the resonance frequency of the measurement probe in the absence of interaction between the measurement probe and a target and regulating the frequency source to operate below this determined resonance frequency.
28. The method according to any of clauses 24 to 27 further comprising the step of monitoring the integrity of the measurement probe by passing a DC current through the measurement probe which is arranged to flow by connecting the probe between two non-equal voltages V_{A} and V_{B} via two resistors: one from V_{A} to one end of the probe, the other from V_{B} to the other end of the probe, measuring the voltage difference across the probe and preventing the current path through the probe and the two resistors from loading the frequency source and detector through the use of a filter.
29. The method according to any of clauses 24 to 28 further comprising the step of verifying normal functionality by controllably switching an electrical impedance across the measurement probe.
30. The method according to any of clauses 24 to 29 further comprising the step of using a fast analogue to digital converter gate array based signal processing circuit to recover information about the profiles of the targets from the probe output signal.
31. The method according to any of clauses 24 to 30, wherein the frequency source is regulated, both in the presence and absence of interaction between the measurement probe and the target, to a frequency which is, simultaneously: (a) not less than ω₀/Q below the resonance frequency ω₀ of the measurement probe (Q being the quality factor of the measurement probe), and (b) not below the frequency ω_{L}=R*/L where R* is the sum of a source impedance from which the measurement probe is driven and its resistance, and L is its inductance.
32. The method of clause 31, wherein Q is between 2 and 20.
33. An apparatus substantially as described and shown in any of the accompanying drawings.
34. A method substantially as described and shown in any of the accompanying drawings.

### BRIEF DESCRIPTION OF THE FIGURES

The present invention may be put into practice in a number of ways and embodiments will now be described by way of example only and with reference to the accompanying drawings, in which:

FIG. 1a shows a schematic diagram in cross section of a part of a turbine engine;

FIG. 1b shows a further schematic diagram in cross section of a part of a turbine engine illustrating a shift in rotor blade position;

FIG. 1c shows a further schematic diagram in cross section of a part of a turbine engine including two measurement probes mounted in axially offset positions;

FIG. 2a shows a schematic diagram of a resonant measurement probe and measurement circuitry;

FIG. 2b shows a schematic diagram of the measurement probe of FIG. 2a in greater detail interacting with a tip of a rotor blade;

FIG. 3 shows a more detailed schematic diagram of the measurement circuitry shown in FIG. 2a;

FIG. 4a shows a schematic diagram of an equivalent circuit of the probe of FIG. 2a;

FIG. 4b shows a second schematic diagram of an equivalent circuit of the probe of FIG. 2a;

FIG. 5 shows a graph of admittance (y-axis) of the probe of FIG. 2a against frequency (x-axis) with and without a target or rotor blade in proximity;

FIG. 6a shows a schematic diagram of the probe of FIG. 2a in cross section including a metallic screen indicating a sensitive volume of space;

FIG. 6b shows a schematic diagram of the probe of FIG. 2a in cross section indicating a sensitive volume of space changing shape when in proximity to the target or rotor blade;

FIG. 7a shows a schematic diagram of the probe of FIG. 2a in cross section indicating the interaction with the target or rotor blade; and

FIG. 7b shows a further schematic diagram of the probe of FIG. 2a in cross section indicating the interaction with the rotor blade.

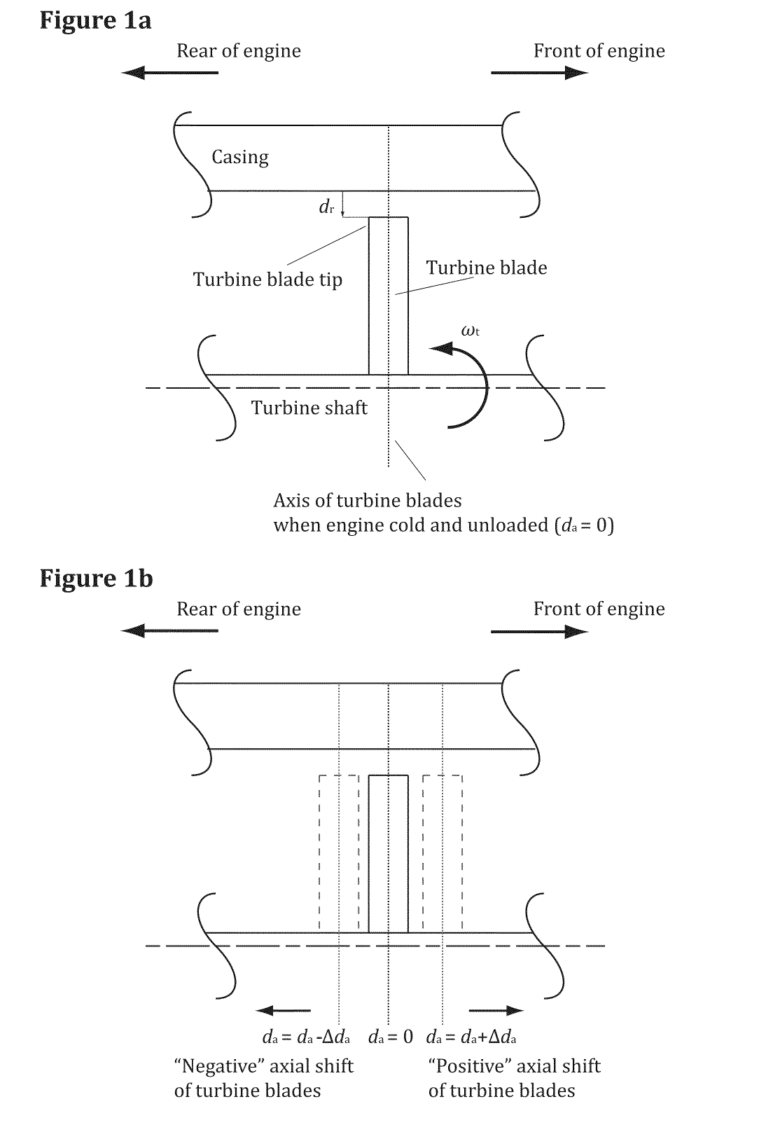

It should be noted that the figures are illustrated for simplicity and are not necessarily drawn to scale.

### DETAILED DESCRIPTION OF THE PREFERRED EMBODIMENTS

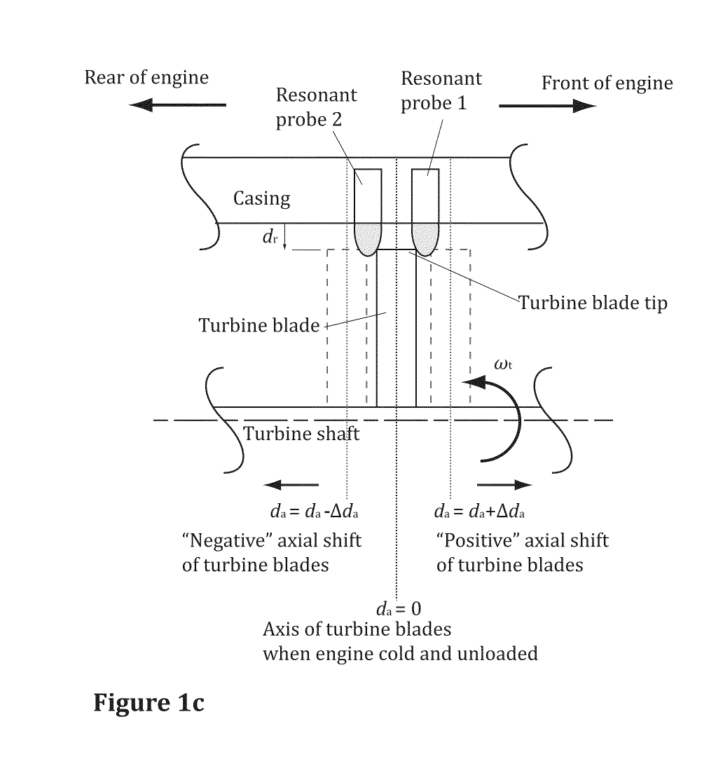

The measurement device has two components: a resonant measurement probe containing a coil having some inductance and some capacitance, and a set of measurement circuitry (“the measurement circuitry”) (FIG. 2a), connected via electrical interconnects (e.g. coaxial transmission line(s)) of arbitrary length.

### The Measurement Probe

The measurement probe includes a coil wound from one or more isolated layers of conducting wire (which might for example be copper or platinum wire) encapsulated in a temperature-resistant package. The coil may be wound on a mandrel. In operation, a radio-frequency (RF) alternating current flows through the coil, giving rise to an RF magnetic field in its vicinity. The package may be designed to partially screen the coil in such a way that when the probe is installed in the engine, its RF magnetic field extends into and only into the region through which the blades pass. One such possible configuration is illustrated in FIG. 2b but as will be appreciated by the reader, many others are possible. Further, the dimensions and geometry of the coil and package may be generally chosen such that the cross-sectional area of the RF magnetic field is, at its largest, smaller or significantly smaller than the tip area of an individual blade so that at any instant in time the maximum number of individual blade tips in the region of the RF magnetic field is either one or two: the former condition corresponding to case that the blade to blade gap is large in comparison with the characteristic dimension of the RF field, the latter to the case that it is small.

The measurement probe is engineered to have a particular resonant response having at least one (but possibly more than one) resonance frequency. In one preferred implementation, this resonant response is wholly or substantially defined by the combination of the self-inductance and inter-winding and layer capacitances of the coil. In another, it may be partly defined by other electrical components or elements (for example lumped capacitors) connected to the coil.

In operation, the measurement probe is excited at a frequency which lies below its resonance frequency if it has just one such frequency or a particular one of its resonance frequencies (generally, but not necessarily the lowest) if it has multiple such frequencies. From henceforth, when we refer to “the resonance frequency” of the measurement probe, this should be understood to mean “the resonance frequency or the particular resonance frequency” of the measurement probe.

### The Measurement Circuitry

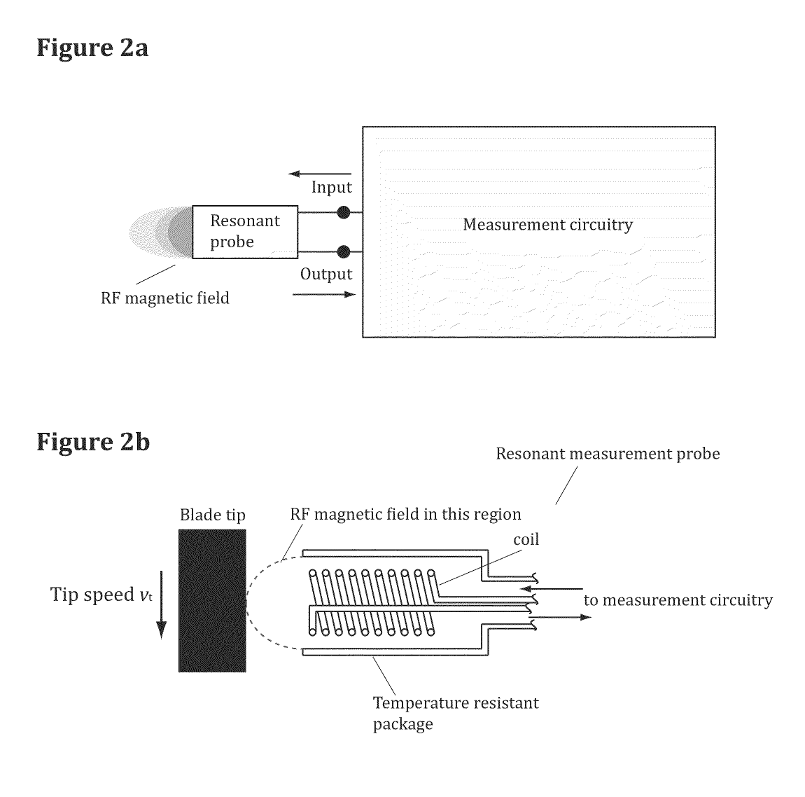

The measurement circuitry, illustrated schematically in FIG. 3, may be subdivided into four parts: 1. A frequency source and frequency regulator (or regulated

frequency source).
2. A detector.
3. A scaling circuit.
4. A validation section.

### The Frequency Source and Frequency Regulator

The role of the frequency source and frequency regulator (or regulated frequency source) is to supply the measurement probe with an input alternating drive signal, having a regulated frequency generally in the radio-frequency (RF) range. In one preferred implementation of the measurement device, the output of the frequency source is regulated to a single fixed frequency ω₁ and frequency regulation is provided by, for example, a crystal. In another, the frequency of the frequency source may be varied in response to changes in the operating conditions of the measurement device using, for example, frequency regulation based on a variable frequency oscillator operating in conjunction with a subsidiary control loop. In such a case, the variable frequency oscillator may either have a continuously variable operating frequency, or may be such that it can be operated at a plurality of fixed frequencies. The input alternating drive signal will have an amplitude.

The frequency source may be arranged to operate either continuously or in a pulsed or switched mode. If it is operated in a pulsed mode, the duty cycle of the pulses may be fixed or variable.

A particular feature of the measurement device is that the frequency of the frequency source is always (i.e. under all conditions of operation or use) regulated to below the resonance frequency of the measurement probe.

Particularly, the frequency source is regulated to a frequency which is, for all operating conditions and both in the presence and absence of interaction between the measurement probe and a rotor blade, simultaneously: (a) not less than ω₀/Q below the resonance frequency ω₀ of the measurement probe (Q being the quality factor of the measurement probe), and (b) not below the frequency ω_{L}=R*/L where R* is the sum of the source impedance from which the measurement probe is driven and its resistance, and L is its inductance.

Q may be between or substantially between 10 and 20, for example. The probe may be configured to have other values of Q and the Q may change depending on the operating conditions of the measurement device.

### The Detector

The role of the detector is to receive an output signal from the measurement probe at the frequency of the frequency source and to derive from this a measurement signal indicative of the blade clearance, the frequency of blade-pass events, and, in some implementations, the spatial profiles of the blades. A blade-pass event may be defined as a passing of a single blade tip within range of the measurement probe. The occurrence of such an event is signalled by an amplitude modulation of the probe output signal at the frequency of the frequency source. The closer the blade to the measurement probe, the larger this amplitude modulation.

The detector may include a demodulator for demodulating the probe output signal. As will be appreciated by the skilled reader, a wide range of demodulator designs are possible. These include, for example, a diode based envelope detector or coherent detectors (such as might, for example, operate via a multiplication of an amplitude regulated derivative of the output signal from the frequency source with the probe output signal).

Optionally, real-time or post processing of the detected output from the measurement probe (using either analogue or digital electronics, or a combination of these) may be incorporated. For example, and particularly, the detector may include a fast analogue to digital converter gate array based signal processing circuit used to measure or monitor the profiles of the passing blades.

### The Scaling Circuit

The function of the scaling circuit is to provide the means for the amplitude of the probe output signal detected at the detector to be scaled according to that of the probe input signal (which may vary due to various factors, including the operating conditions of the measurement device), thus enabling more consistent and more accurate absolute blade clearance measurements to be made.

### The Validation Section

The role of the validation section is to provide the means to verify that the measurement device (both the measurement probe and the measurement circuitry) is operating normally. In one preferred embodiment of such a validation section, a system for real-time monitoring of the integrity of the probe is incorporated in the form of a circuit which passes a small current through the measurement probe. In one preferred implementation of such a circuit, this current is arranged to flow by connecting the probe between two non-equal voltages V_{A} and V_{B} (V_{A}>V_{B}) via two resistors: one from V_{A} to one end of the probe (a) the other from V_{B} to the other end of the probe (b). If the probe is intact, the voltages at a and b are respectively, slightly below V_{A}, and slightly above V_{B}. If the probe has failed in an open-circuit fashion, the voltage at a is equal to V_{A}, and the voltage at b is equal to V_{B}. If the probe has failed by shorting to ground, either one or both of the voltages at a or b is ground. By measuring the voltage difference across the probe, the resistance of the probe can be calculated. This resistance is, in turn, a measure of the temperature of the coil inside the probe. Knowledge of this temperature can be used to improve the accuracy of the blade clearance measurement. In such an implementation of a real-time monitoring feature, it is necessary to ensure that the current path through the probe and the resistors does not load the AC circuitry associated with the frequency source and detector. For this purpose, a filter is preferably employed.

In another preferred embodiment of such a validation section, a circuit is incorporated which has the function of switching an electrical impedance across the connections from the measurement circuitry to the probe in a controllable fashion. In normal operation this impedance is switched out of circuit but, by switching it alternately in and out of the circuit, (at a frequency, for example, of 1 kHz, though a wide range of other frequencies may be used) it can be used when required to verify the proper functioning of the measurement device.

### Operational Features of the Measurement Device

### Overview of Operational Features of the Measurement Device

The operation of the measurement device is as follows: The frequency source included in the measurement circuitry excites the measurement probe with an input alternating (generally radio-frequency, RF) signal at a fixed frequency ω₁ regulated to below its resonance frequency ω₀ under all operating conditions of the measurement device. In operation, the resonance frequency of the measurement probe may be subject to alteration through two mechanisms:
1. Interaction with a blade or blade(s) (which increases its frequency).
2. Environmental factors, notably temperature (which may increase or decrease its frequency).

Therefore, and particularly, the detuning of the frequency source relative to the resonance frequency of the measurement probe is chosen to be sufficiently large that the maximum possible downward shift through mechanism (2) cannot cause it to reduce to zero.

Interaction between the RF magnetic field from the measurement probe and the target or rotor blade(s) has two effects: Firstly, as alluded to above, it causes the resonance frequency of the probe to increase. Secondly, it increases the loss in the measurement probe (that is, it reduces its quality or Q-factor). Both of these effects lead to an increase in the admittance of the measurement probe at the frequency ω₁ of the frequency source and therefore to an increase in the probe output signal associated with a given amplitude of probe input signal.

### General Operational Strengths of the Measurement Device

1. The measurement device achieves advantageous sensitivity and therefore range by virtue of the fact that by operating at a fixed or constant frequency below the resonance frequency of the measurement probe, two effects; (i) the modification of the resonance frequency of the measurement probe, and (ii) the modification of the Q of the probe, contribute to a blade clearance measurement signal which is an amplitude modulation at the source frequency.
2. The measurement device is capable of making highly accurate measurements of absolute blade clearance. This is made possible by the inclusion of the scaling circuit in the measurement circuitry. The scaling circuit is arranged to provide for the detected amplitude of the probe output signal to be scaled according to the amplitude of the probe input signal from the frequency source, thus compensating for changes which might occur in normal operation and would otherwise lead to error.
3. The described measurement device shows excellent immunity to changes in the conductivity of the rotor blades (and is also suitable for use in conjunction with rotor blades or other targets having a wide range of conductivities).
4. The measurement circuitry lends itself to modular design and construction.
5. The measurement device features excellent robustness to changes or adjustments to the lengths of the cables connecting the probe to the measurement circuitry. It is thus suitable for use on production engines as a Line Replaceable Unit (LRU). Either measurement probe or measurement circuitry manufactured to appropriate tolerances may be exchanged reducing the need for calibration or other adjustment.
6. The incorporation of the validation features described in the preceding text allows the operational integrity of the measurement probe and measurement circuitry to be monitored in real time.
7. The possibility of incorporating real-time or post processing of the output from the measurement device allows detailed information about blade profiles to be derived.

### Operating Principles of the Measurement Device

### Equivalent Circuit Model of the Resonant Measurement Probe Assembly

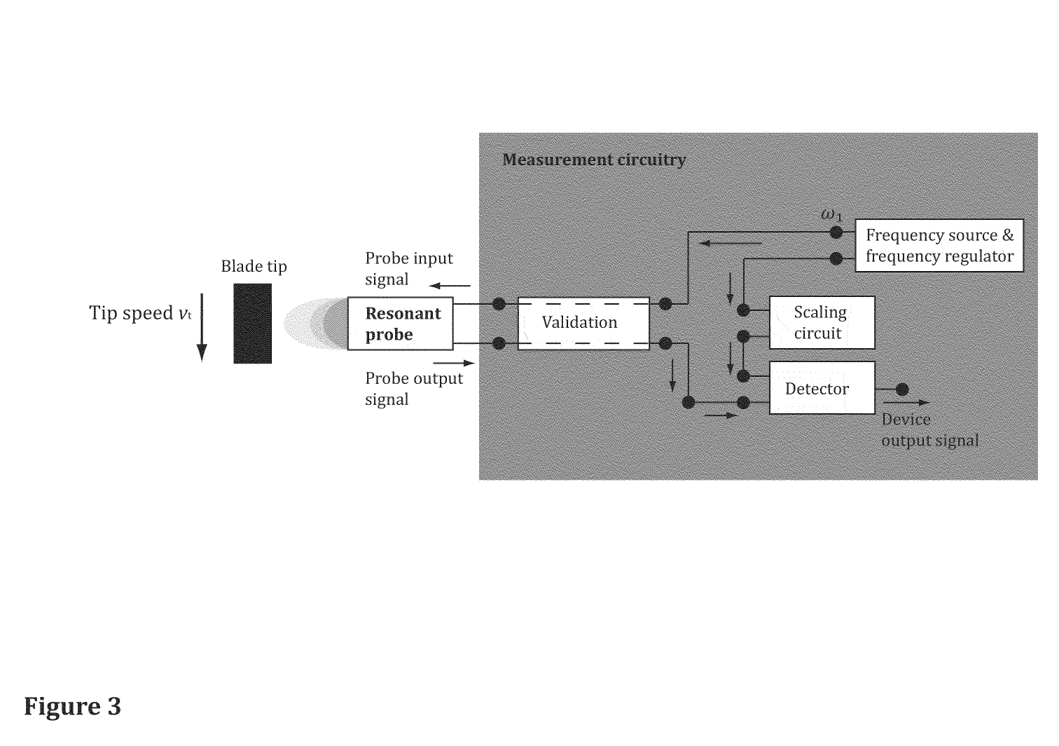

The electrical characteristics of the measurement probe may be analyzed with reference to an equivalent circuit of the form shown in FIG. 4a. The circuit has three components; an inductance L connected in series with a resistance r in shunt with a capacitance C. L represents the effective inductance of the measurement probe coil, r its loss equivalent resistance. C is the effective capacitance of the probe (originating from the parasitic capacitance of the coil inside it and any external capacitance). The admittance Y of the circuit at frequency ω is given, for ωL>>r, by

$$Y = \frac{1 - {ω}^{2} LC + jω Cr}{r + jω L} \qquad ( 1 )$$

Equation 1 may be rewritten

$$Y = \frac{1}{{r}^{*}} + \frac{1}{jω L} + jω C \qquad ( 2 a )$$

where we define a (purely real) “transformed resistance”

$${r}^{*} = \frac{{ω}^{2} {L}^{2}}{r} \qquad ( 2 b )$$

By inspection of Eqns. 2, the equivalent circuit of FIG. 4a may be redrawn in the form shown in FIG. 4b: three components, admittances 1/r*, 1/jωL and jωC connected in shunt.
The resonance frequency ω₀ of the measurement probe is the frequency at which the admittance Y is a minimum:

$${ω}_{0} = \frac{1}{\sqrt{LC}} \qquad ( 3 )$$

### Electrical Characteristics of the Measurement Probe Assembly

The influence of interaction between the measurement probe and a target may be modelled as interaction dependent changes ΔL and Δr* in the effective inductance and transformed resistance of the equivalent circuit of FIG. 4b.

Benefits of the system include that the interaction between the measurement probe and the rotor blade (i.e. target) results in either or both of:
1. A progressive decrease in the effective inductance L with increasing interaction with the target.
2. A progressive decrease in the transformed resistance r with increasing interaction with the target.
   Both of the effects (1) and (2) above result in a progressive increase in the admittance of the measurement probe with increasing interaction with the target (see Eqns. 2). Thus, whether or not one or both effects are present, interaction between the probe and target produces an unconditional increase in the admittance of the probe. Effects (1) and (2) may be summarized:

$$\begin{matrix}{L}^{′} = L - Δ L ( α ) & ( 4 a ) \\ sgn \{ Δ L ( α ) \} = sgn \{ \frac{d Δ L ( α )}{d α} \} = + 1 & ( 4 b ) \\ {r}^{* ′} = {r}^{*} - Δ {r}^{*} ( α ) & ( 4 c ) \\ sgn \{ Δ {r}^{*} ( α ) \} = sgn \{ \frac{d Δ {r}^{*} ( α )}{d α} \} = + 1 & ( 4 d )\end{matrix}$$

Above, α is an “interaction parameter” which takes a value between 0 (no interaction between probe and target) and +1 (maximum interaction between probe and target). By inspection of Eqns. 2, we see that Eqns. 5 are equivalent to the union of Eqns. 4, with the conditions

$$\begin{matrix}r = r + Δ r ( α ) & ( 6 a ) \\ sgn \{ Δ r ( α ) \} = sgn \{ \frac{d Δ r ( α )}{d α} \} = + 1 & ( 6 b )\end{matrix}$$

### Overview of the Operation of the Measurement Device

In operation, the measurement probe may be driven by a probe input signal from a frequency source regulated to a fixed or constant frequency. The frequency of the source ω₁ is regulated to below the resonance frequency ω₀ of the measurement probe in the absence of interaction with the target for all operating conditions of the measurement device (Eqn. 3) and at a frequency which is not below the frequency ω_{L}=R*/L where R* is the sum of the source impedance from which the probe is driven and the resistance of the probe. A signal transmitted through the probe may constitute a probe output signal. In the case that a target is present, the amplitude of the output signal is modulated via the change in the admittance of the probe brought about by the probe-target interaction. The stronger the interaction (and therefore, in general, the closer the target to the measurement probe), the more the admittance of the probe is reduced from its original value (Eqns. 4, 5, 6, and 2) and hence the larger the probe output signal amplitude.

The changes in the admittance of the probe responsible for the signal can be considered to be derived from two interlinked but distinct effects:

(i) Modification of the resonance frequency of the measurement probe.
(ii) Modification of the quality factor of the measurement probe.

For the case that Eqns. 4 and 5 hold, the admittance of the measurement probe in the presence of interaction with the target is (from Eqns. 2, 4 and 5)

$${Y}^{′} = \frac{1}{{r}^{*} - Δ {r}^{*} ( α )} + \frac{1}{jω ( L - Δ L ( α ) )} + jω C \qquad ( 7 )$$

### Effect on Probe Admittance of Probe-Target Interaction Mediated Changes in the Resonance Frequency of the Measurement Probe

From Eqn. 7, it is evident that interaction with the target brings about a shift in the resonance frequency of the measurement probe from its original value ω₀ (Eqn. 3) to a new value

$${ω}_{0}^{′} = \frac{1}{\sqrt{( L - Δ L ( α ) ) C}} \qquad ( 8 )$$

In the limit of small ΔL/L, Eqn. 8 may be written

$${ω}_{0}^{′} ( α ) = {ω}_{0} \sqrt{1 + \frac{Δ L ( α )}{L}} \approx {ω}_{0} ( 1 + \frac{Δ L ( α )}{2 L} ) \qquad ( 9 )$$

We can see from Eqn. 9 that the resonance frequency in the presence of probe-target interaction ω₀′ is always larger than ω₀, the resonance frequency in the absence of probe-target interaction.

As alluded to above, the driving frequency of the measurement probe ω₁ is regulated to below ω₀ in the absence of interaction with the target and may therefore be expressed

ω₁=ω₀(1−ε), ε>0 (10)

Where ε (a positive real number less than unity) is the “initial detuning”

$$ε = \frac{{ω}_{0} - {ω}_{1}}{{ω}_{0}} \qquad ( 11 )$$

For a given implementation of the measurement device, the initial detuning may be chosen via a process of empirical optimization which involves (other ways of determining this initial detuning may be used):
Measuring the amplitude of the measurement device output in response to the proximity of a representative conducting target over a range of potential driving frequencies.
Quantifying the change in the electrical characteristics of the measurement probe over the required range of operating temperatures.

In one preferred implementation of the system, a single operating frequency ω₁ may be chosen so as to optimize the performance and temperature stability of the measurement device, given environmental constraints. In other, more complex implementations of the measurement device, it may be arranged that the frequency at which the measurement probe is driven is varied in response to changes in its temperature (which might for example be determined using a DC conductance measurement). (Note however that in any implementation, the frequency of the frequency source is always regulated to below the resonance frequency of the measurement probe, both in the absence of, and in the presence of, interaction with the target.)

In the presence of probe-target interaction, the detuning may take a modified value

$${ε}^{′} ( α ) = \frac{{ω}_{0}^{′} ( α ) - {ω}_{1}}{{{ω}_{0} ( α )}^{′}} \qquad ( 12 )$$

which, from Eqns. 9 and 10, may be written

$${ε}^{′} ( α ) = ε + \frac{Δ L ( α )}{2 L} ( 1 - ε ) \qquad ( 13 )$$

confirming that detuning from resonance increases as the interaction increases, leading to a corresponding increase in the admittance of the resonant probe at ω₁.

### Effect on Probe Admittance of Probe-Target Interaction Mediated Changes in the Quality Factor of the Measurement Probe

The quality factor Q of the measurement probe in the absence of probe-target interaction may be given by:

$$Q = \frac{{ω}_{0} L}{r} = \frac{1}{r} \sqrt{\frac{L}{C}} \qquad ( 14 )$$

In the presence of interaction, this value may be modified to

$${Q}^{′} ( α ) = \frac{{ω}_{0}^{′} ( L - Δ L ( α ) )}{r + Δ r ( α )} \qquad ( 15 )$$

which using Eqns. 9 and 14, may be written (in the limit of small ΔL/L)

$${Q}^{′} ( α ) = Q \frac{( 1 - \frac{Δ L ( α )}{2 L} )}{( 1 + \frac{Δ r ( α )}{r} )} \qquad ( 16 )$$

Thus, probe-target interactions may reduce the effective quality factor of the probe; an effect which leads to a corresponding increase in the admittance of probe at the driving frequency at ω₁.

### Net Effect on Probe Admittance of Probe-Target Interaction

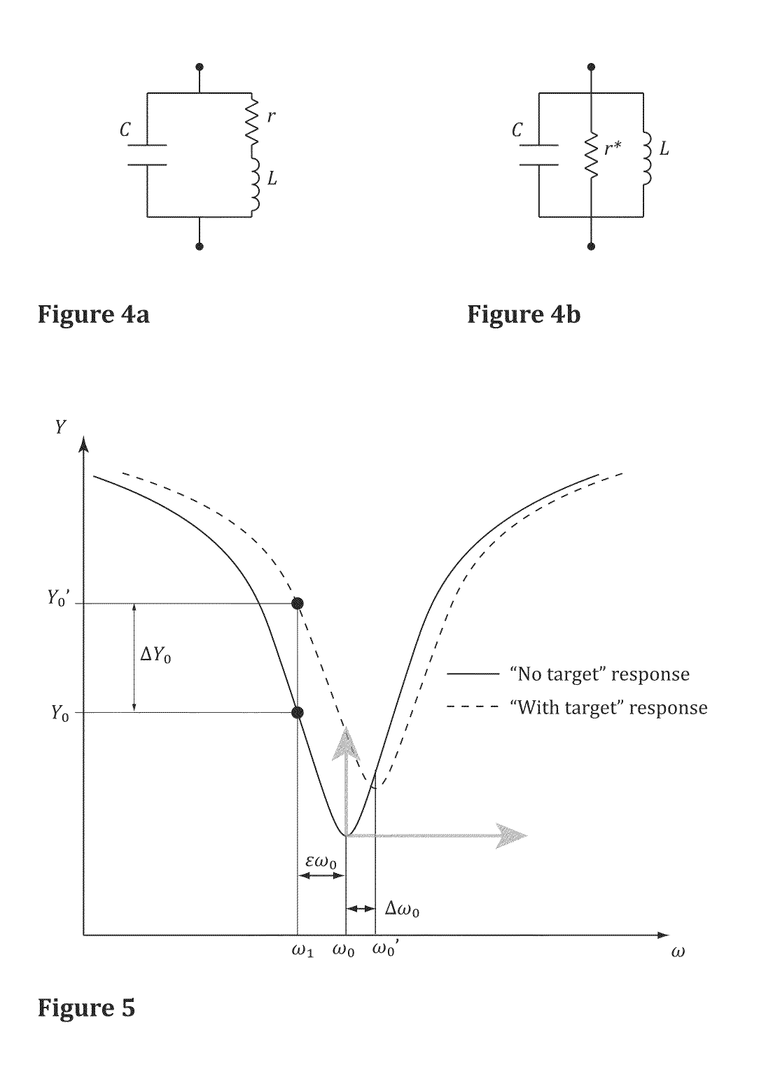

FIG. 5 summarizes the effect on the probe admittance of the probe-target interaction. Plotted schematically is the admittance Y of the probe as a function of frequency ω in the region of the resonance at ω₀ for the case that no target is present (solid) and for the case that a target is present (dashed). As indicated by the large grey arrows, the minimum of the admittance moves upward and to the right as a result of interaction with the target. The upward motion is associated with the change in Q of the measurement probe, the rightward motion with the change in its resonance frequency. Both the rightward and upward motion may contribute to a net increase in admittance ΔY₀.

### Physical Origin of the Electrical Characteristics of the Probe Assembly

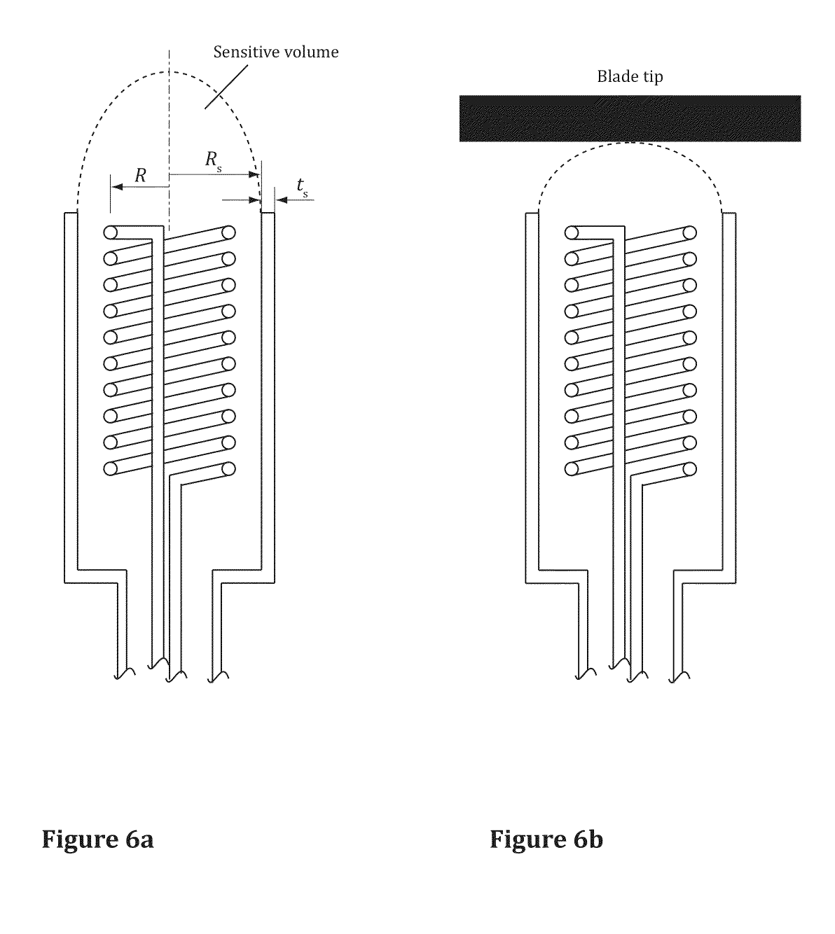

The physical mechanism responsible for the particular electrical response of the measurement probe outlined above is a “compression” of the flux emanating from the coil inside it as a result of interaction with the target (see WO2007GB00350 and associated applications). In this explanatory section we present a simple model of this effect with reference to FIG. 6.

Were the measurement probe suspended far from any electrically conducting surfaces, the instantaneous magnetic field pattern around it when excited would resemble that of a bar magnet; lines of flux would wrap in closed loops around its ends, extending far out into space. However, in the context of the measurement device, the measurement probe is not suspended in free space, but may be surrounded by a cylindrical conducting (generally metallic) screen of radius Rₛ which may be open at one end (FIG. 6(a)). The thickness tₛ of the screen may be arranged to be larger than the skin depth δ₁ at the operating frequency ω₁. That is

$${t}_{s} > {δ}_{1} = \sqrt{\frac{2}{{ω}_{1} {μ}_{1} {σ}_{1}}} \qquad ( 17 )$$

where μ₁ and σ₁ are respectively the permeability and conductivity of the screen material. For practical materials at typical operating frequencies, the condition of Eqn. 17 is readily satisfied with screens having thicknesses of order 1 mm or less. (For example, even for very low conductivity stainless steel; σ₁˜10⁶ Sm⁻¹, μ₁˜μ₀, at ω₁=2π×30 MHz, δ₁˜0.1 mm).

The magnetic flux originated by the coil inside the measurement probe may be accordingly confined by the screen in the direction parallel to its axis.

### Analysis of the Operation of the Measurement Probe Based on a “Flux Compression” Model of Probe-Target Interactivity

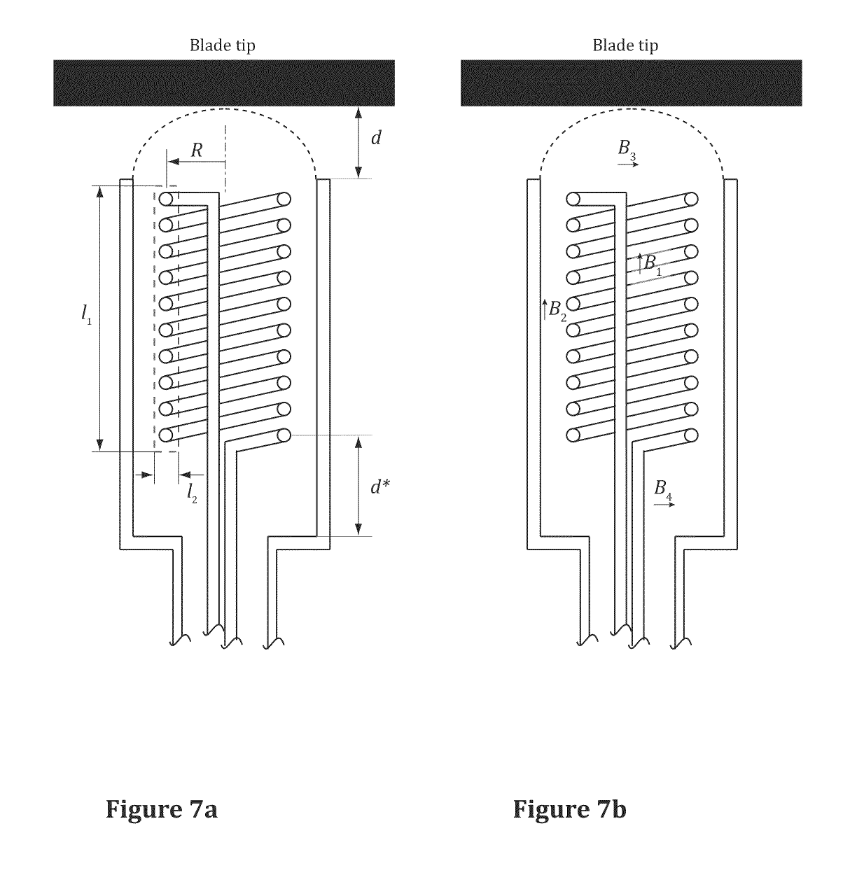

In the absence of a target, the magnetic flux originated by the coil inside the measurement probe extends a distance from its unscreened end which is comparable with its diameter (FIG. 6a). The volume occupied by this flux thus defines a finite “sensitive volume”. When the target enters the sensitive volume, the effect is—by analogy with the description of the screen above—an axial confinement or “compression” of the magnetic flux (FIG. 6b). The effect of this axial compression on the inductance of the coil may be quantified by considering its effect on the magnetic field emanating from the end proximal to the target as the probe-target distance is varied. We elaborate on this description with reference to FIGS. 6 and 7.

FIG. 6 shows a screened coil in the absence of a target (a) and in the presence of (b) a target. As a first step in our analysis we identify a number of important geometrical parameters with reference to FIG. 7a.

The “coil cross section” A₁ is

A₁=πR² (18)

where R is the radius of the coil. The “annular cross section” A₂ is given by

A₂=πRₛ²−A₁ (19)

Both A₁ and A₂ are independent of probe-target interaction. The relationship between the current I flowing in the coil and the magnetic field must, by Maxwell's relations, satisfy

$$\frac{1}{{μ}_{0}} ∮ B d l = NI \qquad ( 20 )$$

where N is the number of turns on the coil and we make the simplifying assumption that the magnetic permeability in the system is everywhere equal to that of free space, μ₀.

We now apply the relation of Eqn. 20 to the measurement probe system assuming that a conducting target is positioned a distance d from the unscreened end of the coil inside it (FIGS. 7a and 7b) and the other end of the coil is screened at a distance d* (note that in general, d* exceeds the maximum value of d). We can evaluate the integral around a rectangular contour of dimensions l₁ (axial) by l₂ (radial) where l₁ is the length of the coil and l₂ is approximately 2r_{w} where r_{w} is the radius of the wire from which the coil is wound, to obtain

$$\frac{1}{{μ}_{0}} \{ ( {B}_{1} + {B}_{2} ) {l}_{1} + ( {B}_{3} + {B}_{4} ) {l}_{2} \} = NI \qquad ( 21 )$$

Here, we assume that along the part of the contour through the centre of the coil the field takes a value B₁, along the part of the contour through the annular region between the coil and the screen, a value B₂ (both B₁ and B₂ being directed along the coil axis), and along the two short sides of the contour values B₃ (target end) and B₄ (screened end) (see FIG. 7(b)). B₃ and B₄ are directed perpendicular to the axis of the coil and are associated with what is commonly referred to as “end effects” (and would be zero for a coil of infinite length).

From the condition ∇·B=0 we can write

$$\begin{matrix}{B}_{1} {A}_{1} = {B}_{2} {A}_{2} \\ = 2 π {RdB}_{3} \\ = 2 π {Rd}^{*} {B}_{4}\end{matrix} \qquad ( 22 )$$

Combining Eqns. (21) and (22), we obtain an expression for the magnetic field B₁ as a function of the probe-target distance d solely in terms of the coil geometry

$${B}_{1} ( α ) = \frac{{μ}_{0} NI}{( 1 + \frac{{A}_{1}}{{A}_{2}} ) {l}_{1} + \frac{{A}_{1}}{2 π R} ( \frac{1}{d} + \frac{1}{{d}^{*}} ) {l}_{2}} \qquad ( 23 )$$

Finally, from the definition of inductance we have

$$L - Δ L ( α ) = \frac{{μ}_{0} {N}^{2} {A}_{1}}{( 1 + \frac{{A}_{1}}{{A}_{2}} ) {l}_{1} + \frac{{A}_{1}}{2 π R} ( \frac{1}{d} + \frac{1}{{d}^{*}} ) {l}_{2}} \qquad ( 24 )$$

Note that the form of the expression on the right hand side of Eqn. 24 directly implies the minus sign applied to the ΔL(α) term on the left i.e. the reduction in inductance with decreasing probe-target distance d alluded to in previous sections.

The change in loss-equivalent resistance Δr(α) of the probe associated with probe-target interaction results from the current density ΔJₜ(α) produced in the target by the coil's alternating magnetic field:

I_{c}²Δr(α)∝ΔJₜ(α)²δₜ (25)

where

$${δ}_{t} = \sqrt{\frac{2}{{ω}_{1} {μ}_{t} {σ}_{t}}}$$

is the skin depth in the target (permeability μₜ, conductivity σₜ). The stronger the interaction, the higher the current density (or in other words, ΔJₜ(α) increases in magnitude as α increases) leading directly to the result summarized by Eqns. 6.

Furthermore, the target may be any of: a rotor blade, surface (including those that have low conductivities), conductive surface, pipe, gas pipe, oil pipe, water pipe, tubing or well casing. For example, the target sensor may be used as a tool for downhole pipe inspection, corrosion or erosion detection, casing or tubing condition evaluation, casing collar location, crack detection and well integrity evaluation especially in the oil and gas industry. In these applications the tool may monitor the surface condition and changes associated with wear, corrosion and eventual failure. Such a tool may work on the inside or outside surfaces of pipes or tubes, for example. This tool works especially well on metallic surfaces and other conductors.

As will be appreciated by the skilled person, details of the above embodiment may be varied without departing from the scope of the present invention, as defined by the appended claims.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A target measurement device comprising:
a measurement probe containing a coil and having some inductance and some capacitance and an admittance and a resonance frequency that change as the separation of the measurement probe and a target changes;
a frequency source arranged to apply at an amplitude, an input alternating signal to the measurement probe;
a frequency regulator arranged to regulate the input alternating signal at a frequency below the resonance frequency of the measurement probe;
a detector arranged to detect an output signal from the measurement probe at the frequency of the frequency source that varies in amplitude with the admittance and resonance frequency of the measurement probe indicating an interaction of the measurement probe with the target;
and a circuit arranged to scale the amplitude of the output signal detected by the detector according to the amplitude of the input signal provided by the frequency source.

2. The target measurement device of claim 1 further comprising a demodulator arranged to demodulate the output signal from the measurement probe.

3. The target measurement device of claim 1 further comprising a circuit arranged to determine the resonance frequency of the measurement probe.

4. The target measurement device of claim 1, wherein the frequency source operates at constant frequency.

5. The target measurement device of claim 1, wherein the frequency source is regulated to a frequency which is, both in the presence and absence of interaction between the measurement probe and a target, simultaneously: (a) not less than ω₀/Q below the resonance frequency ω₀ of the measurement probe (Q being the quality factor of the measurement probe), and (b) not below the frequency ω_{L}=R*/L where R* is the sum of a source impedance from which the measurement probe is driven and its resistance, and L is its inductance.

6. The target measurement device of claim 1 further comprising a validation circuit to enable real-time monitoring of the integrity of the measurement device.

7. The target measurement device of claim 6 in which the validation circuit is arranged to pass a current through the measurement probe by connecting the probe between two non-equal voltages V_{A} and V_{B} via two resistors: one from V_{A} to one end of the probe, the other from V_{B} to the other end of the probe and to measure the resulting voltage difference across the probe.

8. The target measurement device of claim 6 in which the validation circuit further comprises an electrical impedance placed across the measurement probe and configured to be switched alternately in and out.

9. The target measurement device of claim 1 in which the detector further comprises a fast analogue to digital converter gate array based signal processing circuit designed to recover information about profiles of the targets from the probe output signal.

10. The target measurement device of claim 1 further comprising a second measurement probe mounted axially offset to the first measurement probe and connected to the frequency source; and
a second detector arranged to separately detect and process the output signal from the second measurement probe.

11. The target measurement device of claim 1, wherein the target is selected from the group comprising: a rotor, a rotor blade, a rotor blade tip, a surface, a conductive surface, a pipe, a tube, or a well-casing.

12. A system comprising:
a plurality of the target measurement device according to any previous claim;
a transmission line configured to provide an electrical connection between each measurement probe and its corresponding frequency source and detector, wherein each frequency source is configured to supply its corresponding measurement probe with an input alternating signal at a different frequency.

13. A method of measuring target clearance comprising the steps of:
providing a measurement probe containing a coil and having some inductance and capacitance and an admittance and a resonance frequency that change as the separation of the measurement probe and a target changes;
driving the measurement probe with an input alternating signal from a frequency source at an amplitude regulated to a frequency below the resonance frequency of the measurement probe;
detecting an output signal from the measurement probe at the frequency of the input alternating signal that varies in amplitude with the admittance and resonance frequency of the measurement probe indicating an interaction of the measurement probe with the target, and
scaling the amplitude of the output signal detected according to the amplitude of the input signal provided by the frequency source.

14. The method of claim 13, wherein the output signal from the measurement probe is demodulated.

15. The method according to claim 13 further comprising the step of determining the resonance frequency of the measurement probe in the absence of interaction between the measurement probe and a target and regulating the frequency source to operate below this determined resonance frequency.

16. The method according to claim 13 further comprising the step of monitoring the integrity of the measurement probe by passing a DC current through the measurement probe which is arranged to flow by connecting the probe between two non-equal voltages V_{A} and V_{B} via two resistors: one from V_{A} to one end of the probe, the other from V_{B} to the other end of the probe, measuring the voltage difference across the probe and preventing the current path through the probe and the two resistors from loading the frequency source and detector through the use of a filter.

17. The method according to claim 13 further comprising the step of verifying normal functionality by controllably switching an electrical impedance across the measurement probe.

18. The method according to claim 13 further comprising the step of using a fast analogue to digital converter gate array based signal processing circuit to recover information about the profiles of the targets from the probe output signal.

19. The method according to claim 13, wherein the frequency source is regulated, both in the presence and absence of interaction between the measurement probe and the target, to a frequency which is, simultaneously: (a) not less than ω₀/Q below the resonance frequency ω₀ of the measurement probe (Q being the quality factor of the measurement probe), and (b) not below the frequency ω_{L}=R*/L where R* is the sum of a source impedance from which the measurement probe is driven and its resistance, and L is its inductance.

20. The method of claim 19, wherein Q is between 2 and 20.
